(19) United States
(12) Patent Application Publication
(10) Pub. No.: US 2008/0005617 A1
(43) Pub. Date: Jan. 3, 2008

(54) AUTOMATED PROCESSING OF ELECTRONIC LOG BOOK PILOT REPORTS FOR GROUND-BASED FAULT PROCESSING

(75) Inventors: John B. Maggiore, Seattle, WA (US); Steve Yukawa, Seattle, WA (US); William Frans, Seattle, WA (US); Robert J. Manelski, Sammamish, WA (US)

Correspondence Address: LEE & HAYES, PLLC, 421 W. RIVERSIDE AVE., SUITE 500, SPOKANE, WA, 99201, US

(73) Assignee: The Boeing Company, Chicago, IL (US)

(21) Appl. No.: 11/383,450

(22) Filed: May 15, 2006

(51) Int. Cl. G06F 11/00

(52) U.S. Cl. 714/30

(57) ABSTRACT

Automated processing of electronic log book (ELB) pilot reports (PIREPs) are configured to receive ELB PIREPs and prioritize observed faults and potential observed faults included in the ELB PIREPs. In one mode, automated processing involves receiving an observed fault report representing an observed fault. A knowledge base of fault cost data is accessed, facilitating the observed fault being correlated with corresponding fault cost data in the knowledge base of fault cost data. A relative fault cost is determined for the observed fault based on the corresponding fault cost data in the knowledge base. Based on the relative fault cost, a priority is assigned to the observed fault based on the relative fault cost. The priority assigned is communicated to those tasked with remedying observed faults, allowing the highest priority faults to receive the most immediate attention.

### FIELD OF THE INVENTION

The present disclosure relates to aircraft operations, and more specifically, to remedying potential problems observed in the operation of the aircraft.

### BACKGROUND OF THE INVENTION

Commercial flight crews are responsible for tracking a great deal of information about each of their flights and aircraft in logbook records. Some of the most important information flight crews record is fault information, including both a description of the occurrence of the fault and a resolution of the fault. These fault reports are termed “Pilot Reports” or “PIREPs.”

For some systems or types of faults, a dedicated Fault Reporting Manual, or “FRM,” is employed for documenting faults in PIREPs. An FRM usually includes a set of predefined FRM codes that simplify the task of documenting the fault by allowing crew members to record and describe a fault with a predefined code instead of having to write a detailed description. The FRM codes not only simplify the recording task for the crew members, but also reduce the ambiguity in fault reporting, because each of the FRM codes communicates specific information about faults that may be observed.

Historically, PIREPs were maintained in paper-based log books in which crew members were required to write out descriptions or codes to document events and FRMs were paper publications. However, the proliferation of Electronic Log Books, or “ELBs,” has replaced having one or more cumbersome paper-based log books for recording with an automated ELB system. ELBs are computer-based systems that present a graphical user interface and electronic forms for user input. ELBs make the entry of FRM codes very simple for the crew members. ELBs also simplify collection of the data, allowing for FRM codes and other data to be transmitted from the aircraft to a ground-based records system, even while the aircraft is in flight.

FIG. 1 depicts an example of the flow of information of ELB PIREPs. In an aircraft 100, whether in flight as shown in FIG. 1 or on the ground, the flight deck 102 is equipped with digital devices, such as a computer console 104 or another digital device 106 into which the flight crew enters information into ELB PIREPs. The information may include data regarding faults detected in the aircraft 100, engineering parametric data regarding the operation of the aircraft 100, and other types of information. The information is transmitted from the aircraft 100 via satellite 110 to a ground station 120, or by direct transmission (not shown). The ground station 120 is joined by a network 130 to servers 140 or another data collection system. Using workstations 150 on the network 130, analysts access the ELB records stored on the servers to analyze the ELB PIREPs using ground-based fault processing tools or “GBFPTs.”

Transmitting information entered into the ELB in real-time from the aircraft 100 in flight enhances maintenance efficiency. Ground-based software tools allow ground-based personnel to access, research, manage, prioritize and dispose of faults reported on the aircraft 100. Thus, ground-based personnel can analyze and prepare to address reported faults to expedite maintenance activities or make other contingency plans.

### SUMMARY OF THE INVENTION

Automated processing of electronic log book (ELB) pilot reports (PIREPs) are configured to receive ELB PIREPs and prioritize observed faults and potential observed faults included in the ELB PIREPs. In one mode, automated processing involves receiving an observed fault report representing an observed fault. A knowledge base of fault cost data is accessed, facilitating the observed fault being correlated with corresponding fault cost data in the knowledge base of fault cost data. A relative fault cost is determined for the observed fault based on the corresponding fault cost data in the knowledge base. Based on the relative fault cost, a priority is assigned to the observed fault based on the relative fault cost. The priority assigned is communicated to those tasked with remedying observed faults, allowing the highest priority faults to receive the most immediate attention.

This Summary is provided to introduce a selection of concepts in a simplified form that are further described below in the detailed description. This Summary is not intended to identify key features or essential features of the claimed subject matter, nor is it intended to be used as an aid in determining the scope of the claimed subject matter.

### BRIEF DESCRIPTION OF THE DRAWINGS

Embodiments of the present invention are described in detail below with reference to the following drawings.

FIG. 1 (Background) is system diagram depicting a flow of ELB records between an aircraft and ground-based systems;

FIG. 2 is a block diagram of a GBFPT system adapted to use historical fault cost data to perform automated processing of ELB PIREPs;

FIG. 3 is a flow diagram of a GBFPT process;

FIG. 4 is a flow diagram of the generation of historical fault cost data;

FIG. 5 is an information flow map of the generation of historical fault cost data;

FIG. 6 is a block diagram of a prioritization system for identifying and highlighting potentially costly faults;

FIG. 7 is a system diagram for prioritizing observed faults presented in ELB PIREPS; and

FIG. 8 is a block diagram of a computing environment capable of supporting a computer instruction-based implementation embodiment;

### DETAILED DESCRIPTION

Overview

Embodiments of automated processing of Electronic Log Book Pilot Reports (“ELB PIREPs ”) facilitate the use of ground-based fault processing tools (“GBFPT”) to automatically evaluate information manifested in the ELB PIREPs. Historical data is used to determine the costs of various types of faults, including monetary costs, schedule interruptions, performance problems, operational problems, and other and other historical data. Based on these costs derived from the historical data, embodiments of automated processing of ELB PIREPs assigns weights to ELB PIREP entries that indicate the possibility of various faults. Based on these weights, priority is assigned to the faults, and the fault and priority information is communicated to personnel to address the faults and, hopefully, avoid or reduce the costs associated with the occurrence of faults.

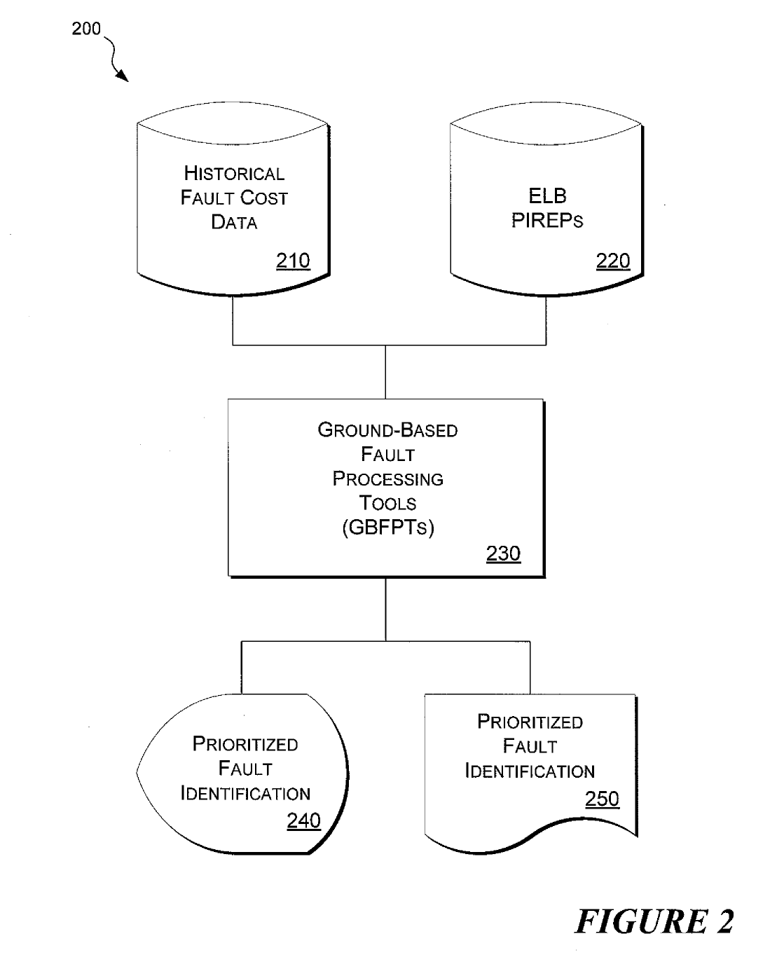

FIG. 2 depicts an exemplary system 200 for automatic processing of ELB PIREPs. Inputs used by the system include a body of historical fault cost data 210 and ELB PIREPs 220. The historical fault cost data 210, the derivation of which is described below, provides a knowledge base with which to assess the ELB PIREPs 220. The ELB PIREPs 220 are compared with and correlated with the historical fault cost data 210 by GBPFTs 230. Based on the historical fault cost data 210 and user customization of the historical fault cost data 210 and/or the GBFPTs 230, as appropriate, ELB PIREPs 220 will be flagged and/or prioritized as presenting faults that should be prioritized to avoid incurring monetary or other costs. The output of the GBFPTs 230 may include displayed prioritized fault identification information 240, or recorded prioritized fault identification information 250 that is presented in hardcopy form or is stored for transmission to appropriate systems or personnel that will respond to the prioritized fault information 250.

In the system of FIG. 2, instead of operators manually reviewing ELB PIREPs 220 as they are received, the GBFPTs 230 used the historical fault cost data 210 to automatically identify the potentially most costly problems, or the most costly potential problems that can be avoided by early action. By prioritizing the fault information based on the relative fault cost of observed faults derived from the knowledge base and presenting the prioritized fault identification information 240 and 250, an entity such as a department or a person responsible for remedying the fault, personnel and other resources can be dispatched to address faults that present the most significant costs or potential costs.

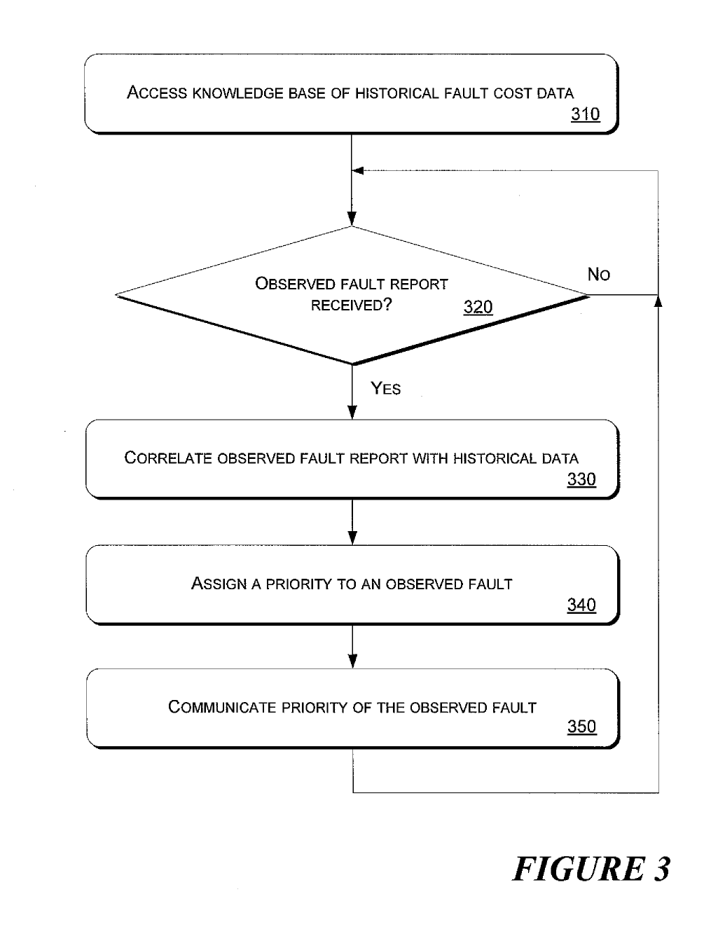

FIG. 3 is a flow diagram of a mode of automated processing of ELB PIREPs. At 310, historical fault cost data is accessed, such as the knowledge base previously described that presents the relative fault cost derived from previously occurring faults. The fault cost data includes one or more of fault data, maintenance actions data, and schedule interruption data. At 320, it is determined if an ELB PIREP is received for automatic processing. If not, the flow diagram loops to block 320 until an ELB PIREP is received. Once an ELB PIREP is received, at 330, the observed fault logged in the ELB PIREP is correlated with the historical fault cost data. At 340, based on the correlation with the historical data, the observed fault is prioritized. At 350, the observed fault and its priority are communicated to personnel or entities responsible for responding to the faults. Because the observed faults are prioritized, those tasked with remedying faults know to first remedy faults that otherwise may result in the highest maintenance or schedule interruption costs.

Embodiments of automated processing of ELB PIREPs apply relevant, value-added knowledge about the information tracked in ELB PIREPs in order to identify and prioritize problems manifest in the ELB PIREP entries. Embodiments also provide methods for displaying and highlighting information regarding potential faults, as well as combining this information with related information to assist in the resolution of the potential faults.

Embodiments of automated processing of ELB PIREPs include and promote one or more of at least six features. First, embodiments calculate a fault priority based on weighted condition factors derived from historical data. Second, observed fault events are displayed, in one mode, using color-coded priority indicators. Third, user-customizable scaling, weighting and overriding of fault priorities is provided to enable personnel to adjust the types and number of faults presented, and how those faults are prioritized. Fourth, observed faults are correlated with other airplane faults recorded by GBFPT to assist in the identification of faults occurring in the future. Fifth, the effectiveness of maintenance actions in response to the observed faults is monitored. Sixth, additional information associated with PIREPs, such as links to relevant documents, are provided to further assist personnel in analyzing and responding to faults, as well as in customizing priorities attributed to future occurrences of faults.

Calculating Observed Fault Priority Using Weighted Condition Factors

According to one mode of automated processing of ELB PIREPs, a relative priority, based on the relative fault cost, is associated with the observed faults. The priority connotes a level of importance or urgency to be accorded the observed faults derived from historical data attributing costs resulting from the occurrence of to such a fault. The priority associated with the observed faults is customizable, as described below.

A relative priority is calculated, scaled as appropriate, and assigned to each type of fault to facilitate automatic prioritization performable by a computing system or another automated system. As will be described further below, the observed fault priority determination includes a wide range of information to develop a knowledge base capable of performing accurate, desired prioritization of observed faults. In one mode, the information includes dispatch allowances and performance and operation impact information. The information used includes historical data, including costs associated with schedule interruptions and performing maintenance. The impact and historical information is then weighted, such as by allowing users to assign weights to the performance and operational impacts or to the different types of historical information. The prioritization also can be weighted by allowing users to assign values to individual observed faults.

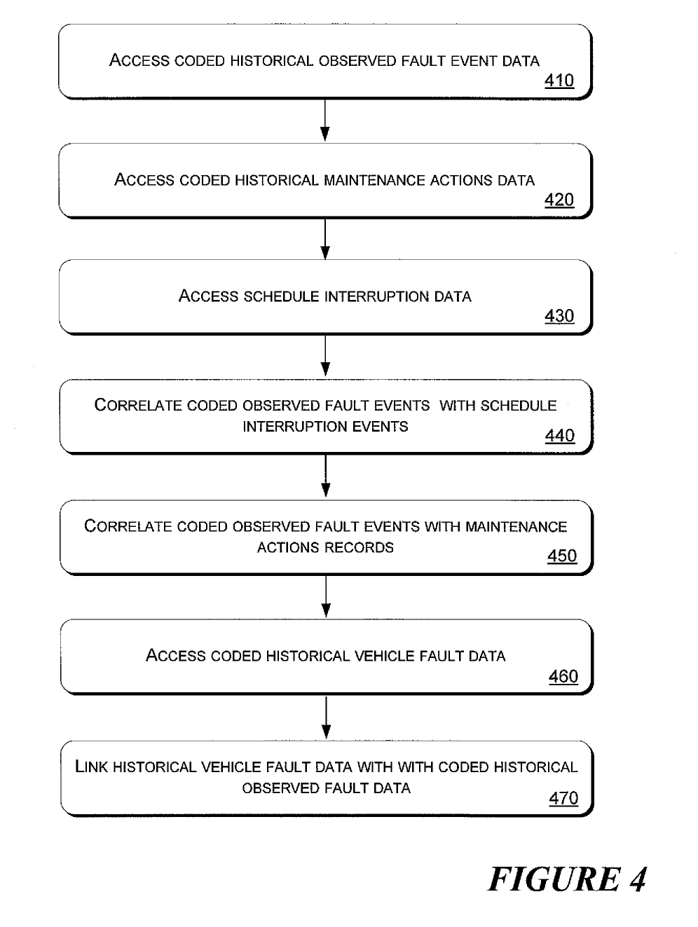

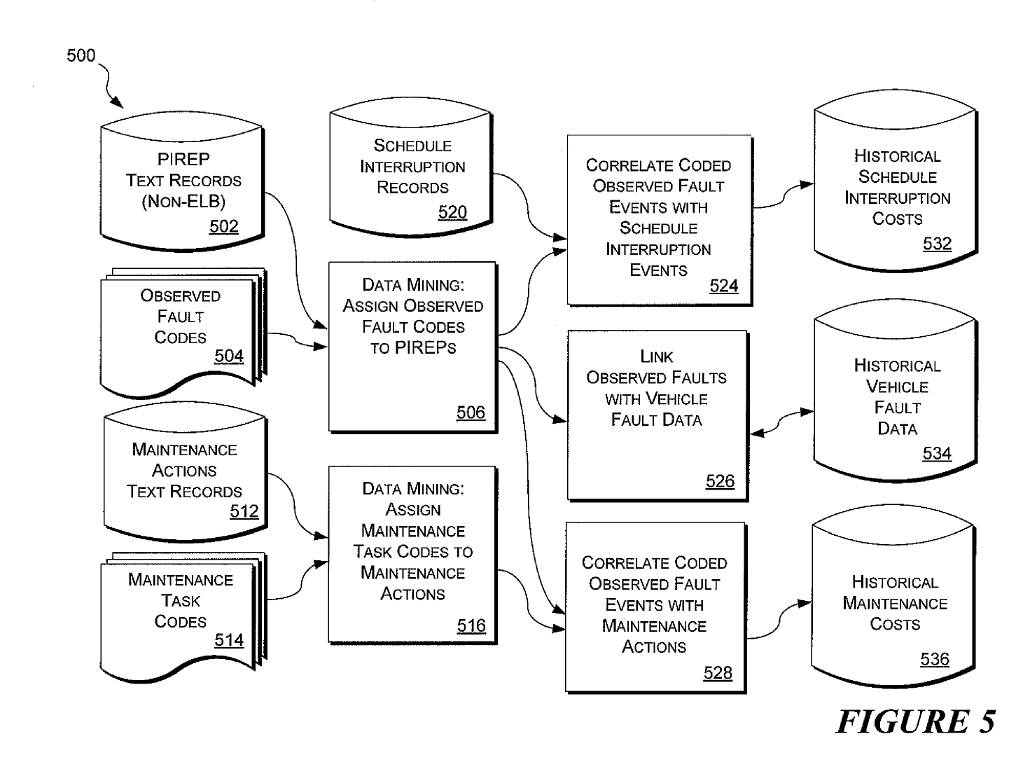

FIG. 4 is a flow diagram of a mode of knowledge development used to generate a body of historical data to facilitate automated fault processing. At 410, coded historical observed fault data is accessed. If available historical observed fault data is not coded, the historical data is associated with fault codes as described below with regard to FIG. 5. At 420, coded historical maintenance actions data is accessed. As in the case of the historical observed fault data, if the historical maintenance actions data is not coded, it is associated with maintenance task codes as described below with regard to FIG. 5. At 430, schedule interruption data also is accessed.

At 440, coded observed fault events are correlated with schedule interruption events. At 450, coded observed fault events are also coded with maintenance actions records. The correlating at 440 and 450 associates the costs of these observed faults, both in terms of maintenance actions and a quantified cost associated with them, as well as the cost resulting from a schedule interruption. In other words, the actual costs of repairing a particular observed fault and the business costs associated with the schedule interruption resulting from the fault are determined.

Based on these costs, handling of observed faults can be prioritized to reduce costs. For example, if a particular observed fault may lead to a more costly observed fault if not repaired quickly, an occurrence of that observed fault may be automatically designated for priority handling to avoid the additional maintenance costs that might result if the observed fault is not resolved quickly. For another example, if a particular observed fault may necessitate a significant schedule interruption and a significant resulting cost, an occurrence of that observed fault may be automatically designated for priority handling to minimize the schedule interruption and its cost.

In addition, to provide information that may assist in the resolution of faults, at 460, coded historical vehicle fault data is accessed. This information, which is described further below, may include fault isolation manuals or service manuals that will assist in resolving the observed fault. By the codes assigned to the historical vehicle fault data, at 470, the historical vehicle fault data is linked to the observed fault data to aid in the resolution of the observed fault.

FIG. 5 illustrates a data map 500 illustrating more specifically how the historical fault cost data is collected. As previously mentioned, if historical observed fault event data and historical maintenance actions data are already assigned representative fault or maintenance codes, they can be readily correlated by those codes. However, because there may be an extensive body of observed fault data or maintenance tasks data that has not already been coded, uncoded data can be mined to increase the knowledge base as depicted in FIG. 5.

FIG. 5 depicts an archive of text records of non-ELB PIREPs 502 being correlated with observed fault codes 504, such as FRM codes, representing the observed faults. A first data mining process 506 is applied to the non-ELB PIREPs 502 using the observed fault codes 504 to assign observed fault codes to the PIREPs. Note that for ELB PIREPs (not shown), fault codes will already be assigned consistent with how entries are made by flight crews in ELB PIREPs. Accordingly, the data represented by the ELB PIREPs need not be mined in order to include the information they present in the historical data.

Correspondingly, maintenance actions text records 512 and maintenance task codes 514 are mined to assign a store of maintenance actions with assigned maintenance task codes 516. A second data mining process 516 is applied to the maintenance actions text records 512 using the maintenance task codes 516 to assign maintenance task codes to the maintenance actions. Again, maintenance records collected in electronic form (not shown), maintenance codes already may have been assigned to the maintenance tasks, and the data need not be mined to associate the appropriate codes with the text records.

Once the data is mined to assign observed fault codes at 506 and maintenance task codes at 516, a store of schedule interruptions records 520 is used to generate the historical data. A first correlating process 524 receives the schedule interruption records 520 and the PIREPs with assigned fault codes to generate historical schedule interruption costs 532. A linking process 526 connects the PIREPs with assigned fault codes and historical vehicle fault data 534. A second correlating process 528 receives the PIREPs with assigned fault codes and the maintenance actions with assigned maintenance task codes to generate historical maintenance costs data 536.

In correlating and associating data, elements common to both observed faults and airplane-reported faults, for example faults reported from the Central Maintenance Computer (CMC), may be used. Faults data may be correlated based on identifiers that identify an airplane model, a flight, a flight phase, a time of fault occurrence, an airplane system affected, and parametric data.

The generation of a knowledge base provides the capability to analyze the effectiveness of maintenance actions performed in response to observed faults reported by the ELB PIREPs. Once analyzed, the relative effectiveness of each maintenance action taken on an observed fault is stored by the GBFPT over time in order to determine and recommend effective maintenance actions to the user if the observed fault occurs again in the future. A recurrence of similar or identical faults on a vehicle after a maintenance action has been applied to the aircraft may suggest a different course of action, a different problem, or change a relative fault cost that may result in a different priority being assigned to a particular observed fault. With all this data being collected in a common repository, it is possible to analyze maintenance actions performed on airplane components to determine the effectiveness of maintenance actions at a component level. The percentage effectiveness for each maintenance action also may be evaluated at the airplane, fleet, or model level.

The knowledge base also allows for information useful in remedying varying faults to be associated with the observed faults as they are reported, as described below. Relevant information may be retrieved by searching document archival and retrieval systems by a specific fault code or by an associated maintenance task. The results of a search for relevant documentation are then organized and presented to a user tasked with responding to the observed fault. Types of information or documentation that may be presented include Minimum Equipment List (MEL) manuals, Fault Isolation manuals, Vehicle Maintenance manuals, and Maintenance & Service advisories.

Determining a Relative Fault Cost to Prioritize Observed Faults

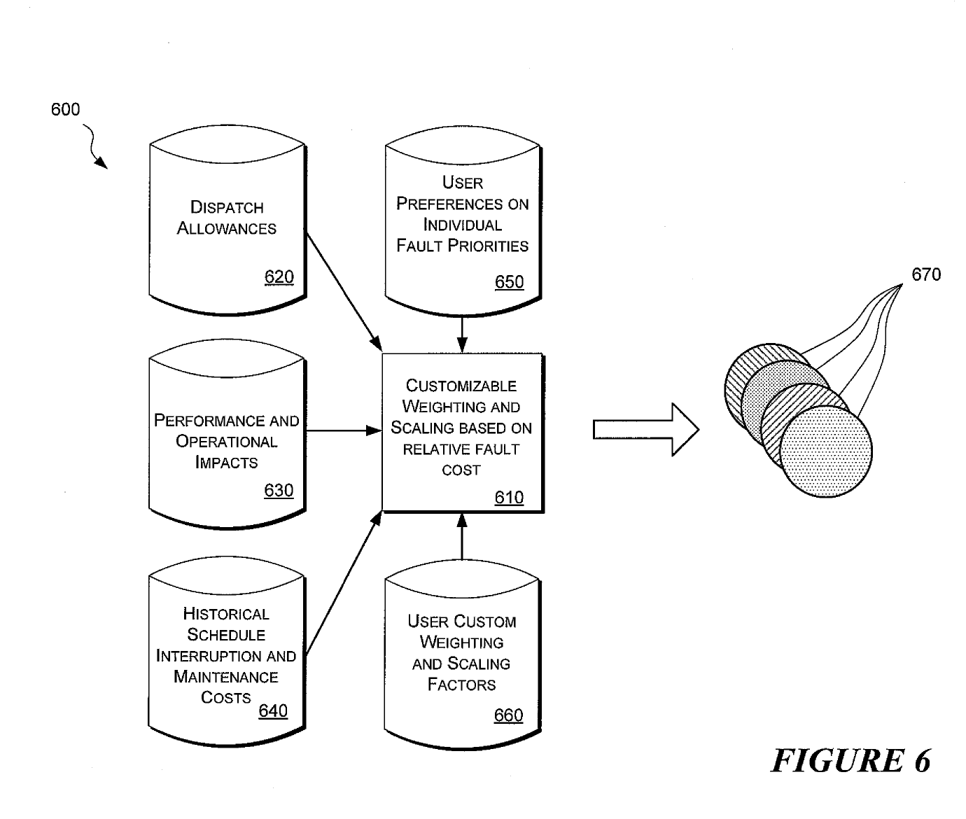

FIG. 6 illustrates a system for prioritizing observed faults. A relative cost for previously occurring faults stored in a historical fault data or a knowledge base or database of such information incorporates a range of information. As illustrated in FIG. 6, a customizable weighting and scaling system 610 generates a priority of an observed fault based on a relative fault cost. The relative fault cost is based on a number of types of information, including dispatch allowances 620, performance and operational impacts 630, and historical schedule interruption and maintenance costs 640.

However, in one or more preferred embodiments, the relative fault cost is not determined purely as a result of information sources 620-640, but by allowing users of the system to adjust how various faults are prioritized. User experience may indicate that particular types of, for example, performance and operational impacts 630 or schedule interruptions 640 will result in a greater fault cost. For example, bad publicity or customer dissatisfaction may result from particular schedule interruptions that will result in a fault cost that practically exceeds another event that may present the same monetary cost. Accordingly, the fault data derived from information sources 620-640 is weighted by user inputs including user preferences on individual fault priorities 650 and user custom weighting and scaling factors 660. With user preference and customization inputs 650 and 660, a relevant valuation of various faults costs will be generated by the customizable weighting and scaling system 610.

Generating the fault cost from the information sources 620-640 and the user preference and customization inputs 650 and 660 may be performed using a number of different processes. One exemplary process includes a weighted summation of the information sources. Thus, for example, x represents the cost of dispatch allowances 620, y represents the performance and operational impacts 630, and z represents the historical schedule interruption and maintenance costs 640. User preferences 650 for each of the dispatch allowances 620, performance and operational impacts 630, and historical schedule interruption and maintenance costs 640 is represented by pₓ, p_{y}, and p_{z}, respectively. Similarly, user custom weighting 650 for each of the dispatch allowances 620, performance and operational impacts 630, and historical schedule interruption and maintenance costs 640 is represented by wₓ, w_{y}, and w_{z}, respectively. Thus, a relative fault cost C for each type of observed fault is determined using Eq. 1:
C=Σpₓ·wₓ·x+p_{y}·w_{y}·y+p_{z}·w_{z}·z (1)
Thus, by calculating the product of each of the weighting factors and each of the respective costs, and totaling those products, a relative fault cost for each type of fault can be calculated. By manipulating the weighting factors, response to observe faults can be adjusted to reduce particular types of costs or to serve other objectives corresponding to the different costs.

Once a relative fault cost is determined for each type of fault, observed faults reported by ELB PIREPs can be prioritized and communicated to personnel or other entities tasked with remedying observed faults. One way to communicate the priority of a fault is to color code the observed faults. For example, if observed faults are communicated to maintenance personnel on a display, highest priority faults, such as those having a relative fault cost over a certain threshold, the observed fault may be displayed in a selected color such as red. For other levels of relative costs, such as the range between the cost threshold for the highest priority designation and a next lower threshold, a different color, such as amber is assigned. Thus, for example, the customizable weighting and scaling system 610 may assign one of four color codes 670 to four different priority levels, and report observed faults or potential observed faults with the appropriate color code. For example, urgent priority faults may be coded in red, high (but not urgent) priority faults may be coded in amber, medium priority faults may be coded in yellow, and non-priority faults may be coded in green, in white, or without any color at all. Accordingly, a fault that would ground an aircraft or present a hazard may be coded in red, a fault that would cause long-term or costly damage to the aircraft if unchecked may be coded in amber, a fault that would be unpleasant for passengers, such as restroom or galley malfunction may be coded in yellow, and a purely cosmetic fault may be coded with no color at all.

As a result, personnel tasked with remedying faults can immediately recognize what are the highest priority tasks for them to address. Moreover, as a result of automating the prioritization of the observed faults or potential observed faults, as soon as a fault or potential fault is reported, such as via an ELB PIREP, a priority of responding to the reported fault or potential fault is immediately prioritized as it is reported to personnel responsible for remedying the faults reported.

The user preferences on individual fault priorities 650 may be used to specify priority classifications on a per-fault basis to override priorities that may be set automatically. For example, in response to a fault of particular concern to flight or ground crew members, a user may associate a high priority with a particular observed fault to ensure that the fault receives immediate attention. Changes manifested in the user preferences 650 may be implemented across the system for those faults, or applied only for the instance motivating the change in the user preferences 650.

System for Automatically Prioritizing Observed Faults

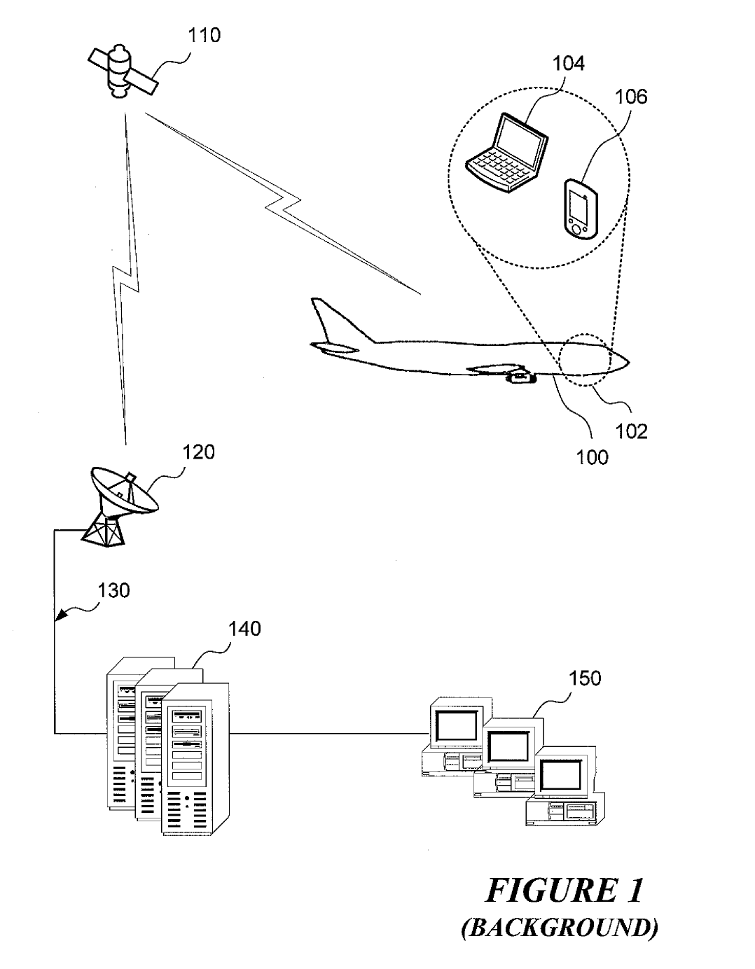

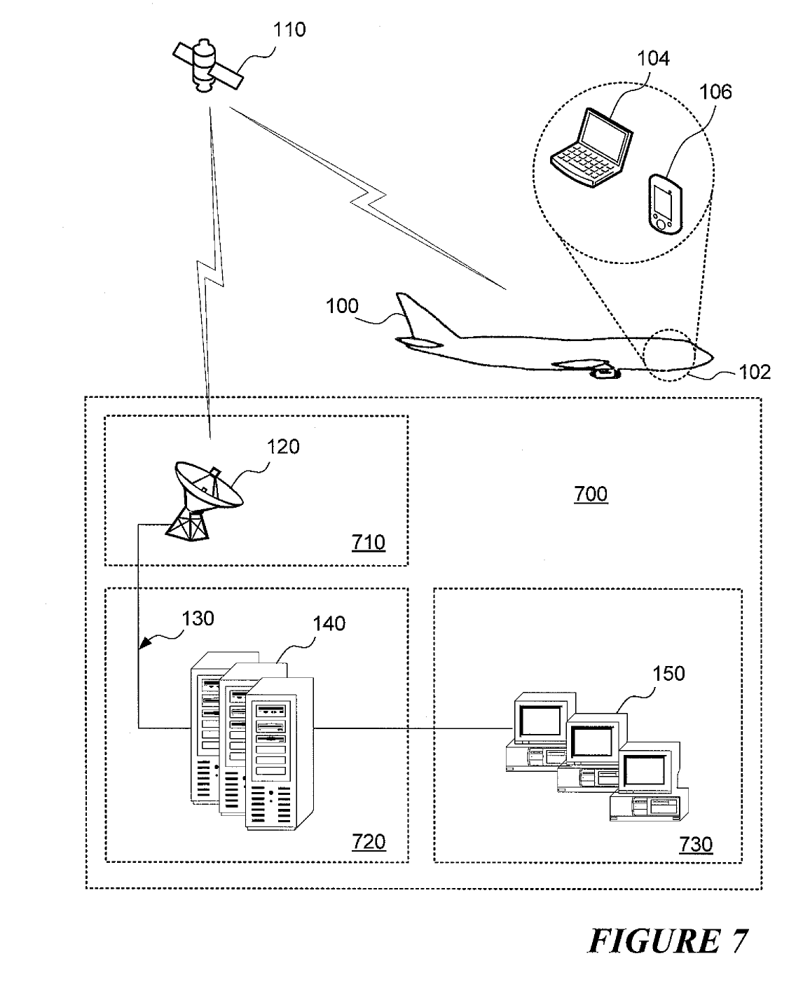

FIG. 7 depicts a system for automatically prioritizing and reporting observed faults in the context depicted in FIG. 1. In FIG. 7, observed faults or observed potential faults occurring on an aircraft 100 are reported in ELB PIREPs by flight crew members on the flight deck 102 using digital devices 104 and 106. The ELB PIREPs are transmitted via satellite 110 to a ground station 120, or by direct transmission (not shown). The ground station 120 is joined by a network 130 to servers 140 or another data collection system. Data is analyzed, prioritized, and reported on workstations 150 on the network 130.

In this context, an automatic fault prioritizing system 700 is used. The fault prioritizing system 700 includes a fault reporting receiver, such as an ELB PIREP interface 710 that receives the electronic reports from an aircraft. In FIG. 7, the ELB PIREP interface 710 is graphically depicted as a satellite ground station, but it will be appreciated that the ELB PIREP interface 710 may include any interface operable for receiving ELB PIREPs. A knowledge database 720 is maintained on one or more servers 140 on the network 130. The knowledge database 720 includes various forms of information as previously described to create a system indicative of the relative fault cost to be associated with previously occurring, recorded faults. A fault prioritizer 730 is depicted as one or more workstations 150 in FIG. 7, but may include the servers 140 or other systems. The fault prioritizer 730 receives the ELB PIREPs and accesses the knowledge base to facilitate the automatic prioritization of reported faults, and display the prioritized faults to those tasked with remedying those faults. The fault prioritizer 730 also allows users to customize the prioritization of faults as previously described.

Exemplary Operating Environment for Automated Processing of ELB PIREPs

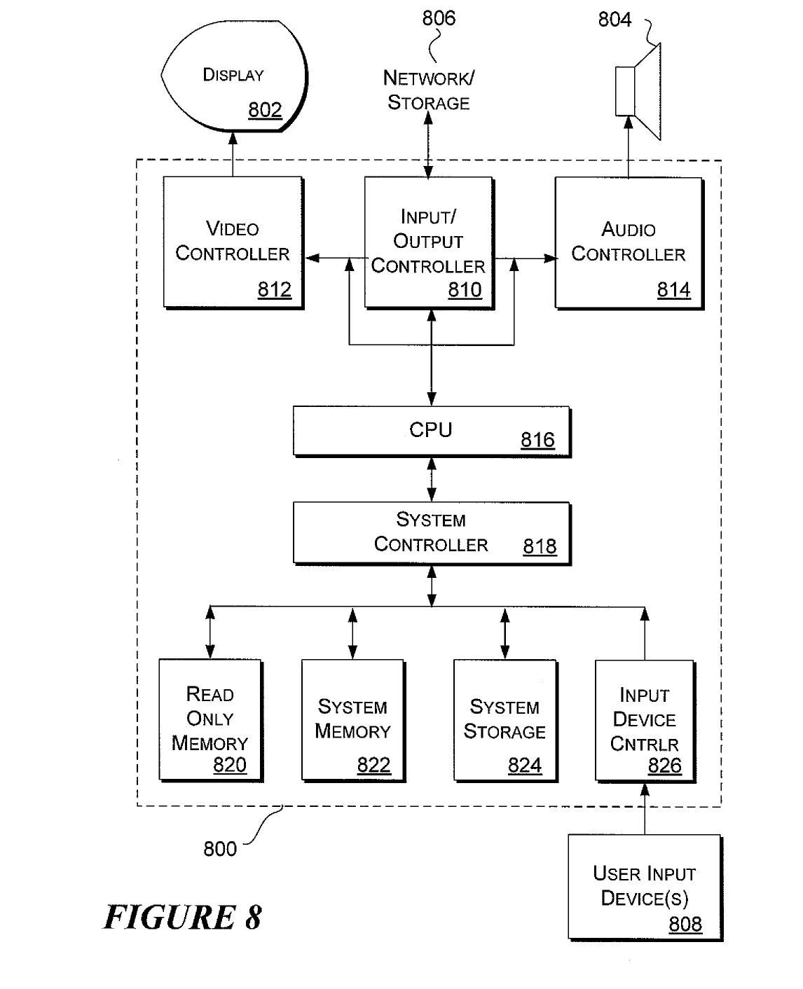

FIG. 8 is a generalized computer system 800 operable to support operation of a software embodiment of the present invention. The computer system 800 is representative of the capabilities of digital devices 104 and 106 (FIG. 1) used aboard the aircraft 100, as well as ground-based servers 140 or workstations 150 that are used to process the information generated by the ELB PIREPS maintained by the digital devices 104 and 106 aboard the aircraft 100.

The computer system 800 is operable for controlling a display 802, such as a monitor, and an audio subsystem 804, for presenting information to a user. The computer system 800 communicates information with a local area network or other network, such as network 130 (FIG. 1) in a shared access environment, and/or with other storage 806. The computer system 800 also receives user input from a wired or wireless user keypad 808, which may be in the nature of a computer keyboard, or another input device such as a touch sensitive or pen-sensitive interactive display.

The computer system 800 receives input via an input/output controller 810, which directs signals to and from a video controller 812, an audio controller 814, and a central processing unit (CPU) 816. In turn, the CPU 816 communicates through a system controller 818 with input and storage devices such as read only memory (ROM) 820, system memory 822, system storage 824, and input device controller 826.

While preferred and alternate embodiments of the invention have been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

What is claimed is:

1. A computer-implemented method, comprising:
accessing a knowledge base of fault cost data;
receiving an observed fault report representing an observed fault;
correlating the observed fault with corresponding fault cost data in the knowledge base of fault cost data;
determining a relative fault cost for the observed fault based on the corresponding fault cost data; and
assigning a priority to the observed fault based on the relative fault cost.

2. The computer-implemented method of claim 1, wherein the knowledge base of historical data includes at least one of:
fault data wherein each type of fault is associated with a fault code;
maintenance actions data wherein each type of maintenance actions is associated with a maintenance tasks code;
schedule interruption data; and
historical fault information including information at least one of describing the fault and describing a process for rectifying the fault.

3. The computer-implemented method of claim 2, further comprising at least one of:
associating uncoded fault data with a fault code indicative of a nature of an observed fault; and
associating uncoded maintenance actions data with a maintenance task code indicative of a nature of the maintenance actions.

4. The computer-implemented method of claim 1, wherein the observed fault report includes an electronic log book (ELB) pilot report (PIREP) received from an aircraft via transmission from the aircraft to a ground based fault processing system.

5. The computer-implemented method of claim 1, wherein correlating the observed fault with corresponding fault cost data includes correlating an observed fault code associated with the observed fault with at least one code associated with entries in the knowledge base of fault cost data.

6. The computer-implemented method of claim 5, wherein the codes include at least one of:
fault codes; and
maintenance task codes.

7. The computer-implemented method of claim 1, further comprising determining the relative fault cost for the observed fault, including:
assigning weights to elements of fault cost data; and
determining a collective weight by totaling the plurality of weighted elements.

8. The computer-implemented method of claim 7, wherein the weights assigned are adaptable based on user inputs.

9. The computer-implemented method of claim 1, further comprising communicating the priority of the observed fault.

10. The computer-implemented method of claim 9, wherein communicating the priority of the observed fault includes:
assigning a respective color code corresponding with the relative fault cost;
associating the respective color code with the observed fault in presenting the observed fault to an entity tasked with remedying the observed fault.

11. A computer-implemented method, comprising:
accessing a knowledge base of fault cost data representing fault cost data for a plurality of previously occurring faults, wherein the fault cost data at least one of includes and represents a plurality of entries including at least one of:
fault data wherein each type of fault is associated with a fault code;
maintenance actions data wherein each type of maintenance actions is associated with a maintenance tasks code;
schedule interruption data; and
historical fault information including information at least one of describing the fault and describing a process for rectifying the fault;
correlating an observed fault with corresponding fault cost data in the knowledge base of fault cost data, wherein the observed fault is reported in an electronic log book (ELB) pilot report (PIREP) received from an aircraft; and
determining a relative fault cost for the observed fault based on the corresponding fault cost data.

12. The computer-implemented method of claim 11, further populating the knowledge base of fault cost data, including:
associating uncoded fault data with a fault code indicative of a nature of an observed fault; and
associating uncoded maintenance actions data with a maintenance task code indicative of a nature of the maintenance actions.

13. The computer-implemented method of claim 11, wherein correlating the observed fault with corresponding fault cost data includes correlating an observed fault code associated with the observed fault with at least one code associated with entries in the knowledge base of fault cost data.

14. The computer-implemented method of claim 11, wherein determining the relative fault cost for the observed fault, including:
assigning weights to elements of fault cost data; and
determining a collective weight by totaling the plurality of weighted elements.

15. The computer-implemented method of claim 14, wherein the weights assigned are adaptable based on user inputs.

16. The computer-implemented method of claim 11, further comprising assigning a priority to the observed fault based on the relative fault cost.

17. The computer-implemented method of claim 16, further comprising communicating a priority of the observed fault based on the relative fault cost.

18. The computer-implemented method of claim 17, wherein communicating the priority of the observed fault includes:
assigning a respective color code corresponding with the relative fault cost;
associating the respective color code with the observed fault in presenting the observed fault to an entity tasked with remedying the observed fault.

19. A system for prioritizing an observed fault communicated by an electronic log book (ELB) pilot report (PIREP), comprising:
an ELB PIREP interface operable to receive an ELB PIREP from an aircraft;
a knowledge database of fault cost data associated with previously occurring faults; and
a fault prioritizer configured to communicate a priority of remedying the observed fault, wherein the fault prioritizer is configured to:
compare an observed fault reported by the ELB PIREP with the knowledge database to identify a relative fault cost associated with at least one corresponding fault stored in the knowledge database;
identify the relative fault cost of the corresponding fault;
assign the priority to the observed fault based on the relative fault cost; and
communicate the priority by associating a respective priority code with the observed fault upon reporting the observed fault to the entity tasked with remedying the observed fault.

20. The system of claim 19, wherein the priority code is a color code representative of the priority of the observed fault.
